(19) United States
(12) Patent Application Publication
(10) Pub. No.: US 2003/0106402 A1
(43) Pub. Date: Jun. 12, 2003

(54) Methods and apparatus for processing reclaimed tire tread strips

(76) Inventor: Joseph J. Solon, Auburn, NY (US)

Correspondence Address: Laurence R. Brown, 6404 Bardu Court, Spring Field, VA, 22152, US

(21) Appl. No.: 10/005,696

(22) Filed: Dec. 7, 2001

(51) Int. Cl. B26D 7/08; B26D 1/12; B23D 19/00

(52) U.S. Cl. 83/19; 83/39; 83/176; 83/343; 83/495; 83/675; 83/678; 83/951

(57) ABSTRACT

This invention provides patterned tread strips of uniform shape and dimension from salvaged tire carcass tread strips adapted for producing products requiring stacked layers of tread strips. Novel methods of and apparatus for shaping the tread strips in one embodiment results in trimming edges of substantially rectangular shaped tread strips salvaged from tire carcasses having two shorter ends and two longer sides to produce precisely uniform width between the longer sides. Thus the longitudinal tread strips may be passed from one end longitudinally through a power actuated strip feeder which establishes slicing means operable at designated spacings near opposite edges of the tread strips to cut away edges and produce uniform longitudinal strip widths between said two shorter ends as the strips pass through the strip feeder. Other shaping embodiments of the invention include tread surface shavers for producing strips of precise thickness, and length cutters to provide specified lengths. Apertures and indentations are introduced in the tread strips and strip rubber and fabric is relieved of inherent tensions and compressions by means of laser treatment in other embodiments of the invention, thus providing a set of tools for a system of comprehensively shaping tread strips at serial processing stations located along a transit path.

### TECHNICAL FIELD

This invention relates to methods and apparatus for producing useful products from stacked layers of discarded tire tread strips and more particularly it relates to inexpensive tooling for feeding and processing raw tire tread strips to obtain precise dimensions for making multi-layered products such as beams or posts.

### BACKGROUND ART

It is generally known in the art to cut away sidewalls of discarded tire carcasses to salvage rectangular tread strips having two shorter ends and generally parallel longer edges from which various products are made.

Typical prior art for producing tread strips from discarded tires and products formed from such tread strips includes the following U.S. Pat. No. 5,834,083, Nov. 10, 1998 to A. J. Pignataro, Jr. for USED TIRE RECYCLING, ETC., which discloses beams and posts formed from stacked layers of discarded tire carcass tread strips that are sheared to uniform widths and thicknesses.

No particular processing equipment is referenced for this purpose. Conventional methods of obtaining tire tread strips of uniform width are typified by U.S. patents of R. L. Barclay, namely: U.S. Pat. No. 4,976,178, Dec. 11, 1990, for ANNULAR SCRAP SEGMENTS IN TIRE REDUCTION, which in a complicated manner forces and holds an annularly buckled discarded tire carcass for cutting into three separate annular portions, one of which is a narrow annular tread portion at the crown of the tread, and U.S. Pat. No. 4,914,994, Apr. 10, 1990, for AUTOMATED APPARATUS FOR DEBEADING OF SCRAP TIRES disclosing the cutting of a tire carcass to eliminate the bead and produce a U-shaped tread strip of a length determined by the tire carcass being processed and embodying attached sidewalls.

As seen from the disclosure in U.S. Pat. No. 5,340,630, B. A. Tripp, Aug. 23, 1994, for TWO PLY MATERIAL MADE FROM USED VEHICLE TIRES, an annular tread cut from a tire carcass is transversely cut to provide a flat rectangular work product.

There are problems using the raw tire tread strips supplied by the initial carcass processing procedures in products requiring precision matching of substantially identical tread strips, since scrap tires of different sizes and from different manufacturers are not consistent in dimensions thus producing strips of different length and width and thickness. Thus, for manufacturing tire carcass products requiring precision dimensions, several desirable processing steps for re-working the tire tread strips reclaimed from discarded tire carcasses add considerable cost in processing tooling heretofore known requiring excess labor man-hours from skilled artisans. This offsets the considerable advantage of reclaiming waste tires to prevent breeding of mosquitos in tire carcasses discarded at outdoor storage dumps. Further disadvantages are particularly present in any product lines requiring stacked layers of reclaimed tire tread strips which retain internal stresses and fabric conditions that prevent a natural inclination to lie flat.

Accordingly the present invention improves the state of the art with processes and simplified apparatus for precisely shaping raw reclaimed tire tread strips.

### DISCLOSURE OF THE INVENTION

This invention thus serves to process tread strips from salvaged tire carcasses particularly for producing products requiring stacked layers of tread strips. Thus novel processing methods and simplified machinery are provided for reshaping the substantially rectangular shaped tread strips salvaged from tire carcasses having two shorter ends and two longer sides to provide precision work pieces, typically tread strips which must be precisely dimensioned for stacking on top of each other to form beams or posts.

In this process, the longitudinal tread strips are grasped at one end and longitudinally transported by a simplified power actuated tread strip feeder and edge trimming mechanism to trim opposite edges of a raw tire tread strip to form strips of precise widths. Other simple and inexpensive product shaping and reconfiguration tools such as buffers, punches or fabric relaxers, may then in sequence process the tread strip in transit. In a preferred embodiment, the strip feeder mechanism comprises an electric drive motor with appropriate speed reduction gears that drive counter rotating roller bar assemblies that simultaneously trim off two opposed outer strip edges precisely to form a tread strip of designated width generally encompassing substantially the entire width of a reclaimed tire carcass tread. Other simultaneously operable interacting processing tools may include buffers, cutters, indenters, fabric de-tensioning devices and precision length slicing roller bars operable during a single transit cycle.

These features with further embodiments, objects, advantages and features of the invention will be set forth hereinafter in more detail in the following specification, claims and accompanying drawings.

### BRIEF DESCRIPTION OF THE DRAWINGS

In the accompanying drawings, wherein like reference characters in the separate view identify similar features to facilitate comparison:

FIG. 1 is a block system diagram of the interrelated method and apparatus features afforded by this invention;

FIG. 2 is an exploded longitudinal end view sketch of a mechanism for the feeding and slicing of a raw tire tread strip in transit through a longitudinal feed path to show entering raw strips and exiting processed strips of precise width;

FIG. 3 is a front view sketch looking into the transport and edge slicing apparatus of a preferred embodiment of the invention;

FIG. 4 is a side view sketch of the interacting transport and slicing wheels provided in a preferred embodiment of the invention,

FIG. 5 is an end view sketch of a preferred embodiment of apparatus for indenting patterns along the two longitudinal sides of the tread strips of the strip in transit following the slicing of the tread strips into a desired precise width along their longitudinal length, and

FIG. 6 is a sketch of a tire tread strip processing system with multiple stations positioned along a transit path through which the tread strip travels for sequential automated configuration of two or more of the width, length, shape, flatness and thickness of a tread strip during transit.

### PREFERRED EMBODIMENTS

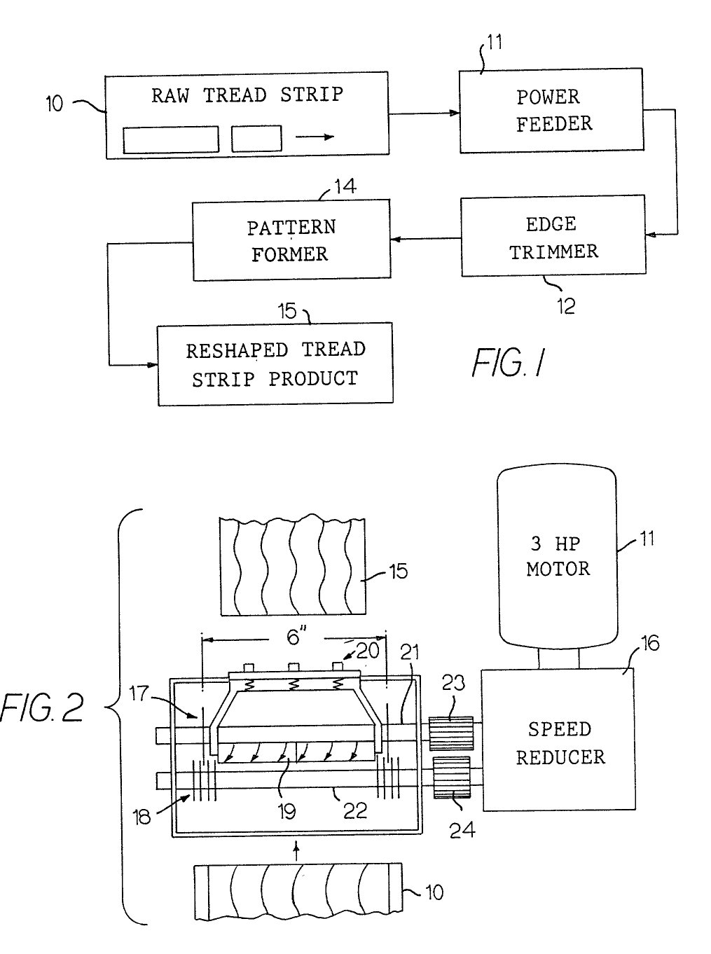

Now with reference to the accompanying drawings, the general nature of the invention is set forth in the block diagram of FIG. 1, wherein an input raw reclaimed tire tread strip 10, generally rectangular in shape is processed to obtain a precisely reshaped tread strip output product 15. The power feeder 11 grasps and pulls the raw tread strip 10 longitudinally into processing machinery, typically the edge trimmer 12 which precisely produces a strip of designated width, typically six inches. Other patterns may also be formed in the strip sequentially during transit at station(s) 14.

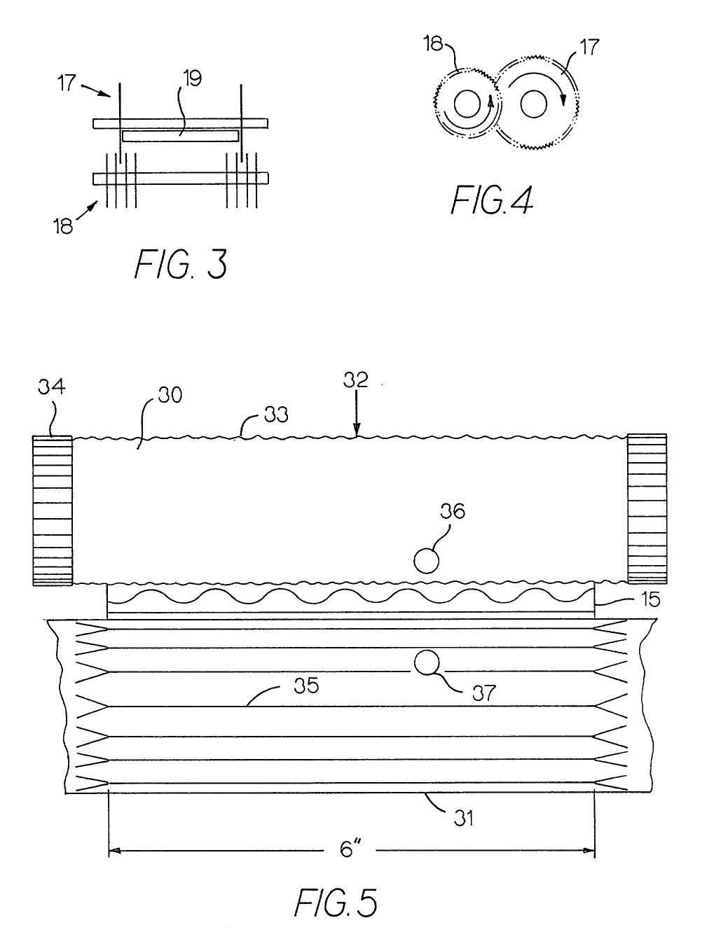

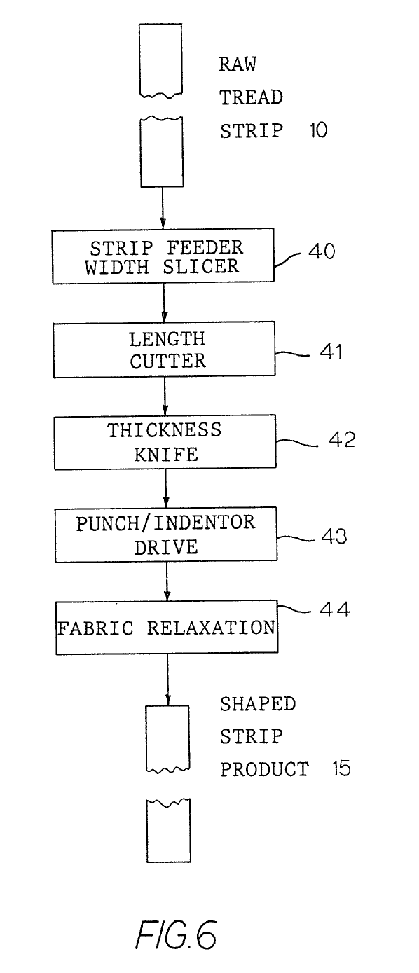

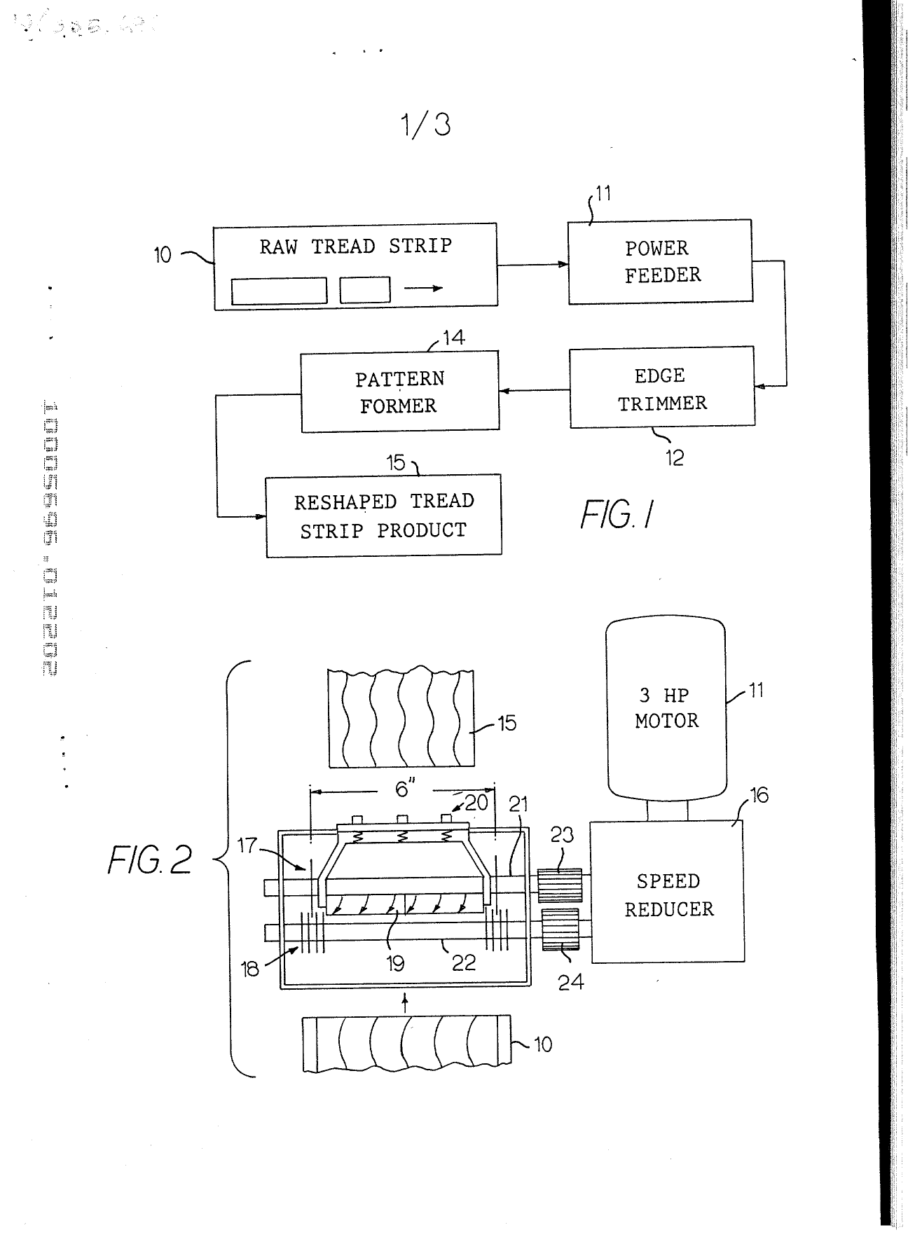

FIGS. 2, 3 and 4 relate to the preferred method and apparatus embodiment for producing tire tread strips of precise width that may be stacked to form beams, posts or other multi-layered tire tread strip products. This exploded view shows the raw tread strip 10, which is fed longitudinally into the edge trimmer mechanism from its shown front view and is discharged as a six inch wide reshaped strip 15.

The three horsepower drive motor 11, though the speed reducer gear box 16 rotates the counter rotating transit-cutter wheels 17, 18 located on shafts 21, 22 at speeds determined by the appropriate drive gears 23, 34. Such cutting wheels are used for example in the Barclay U.S. Pat. No. 4,976,176. In this preferred embodiment there are sets of four transport blades, which grab the tire strip and pull it through, two on either side of a single cutting wheel located at the outer edges of the raw tire tread strip being processed, thus to trim off edges extending beyond the designated width of six inches. The cutting blade 17 rotates at 175 RPM, and the transport blades 18 rotate at 45 RPM. Thus the strip is transported at a constant speed determined by the rotation speed of the transport blades.

A further roller 19 is spring biassed at 20 to the transporter frame to grasp the tire tread for transport in cooperation with the transport blades 18 as driven by the transport blades 18 or other means not shown.

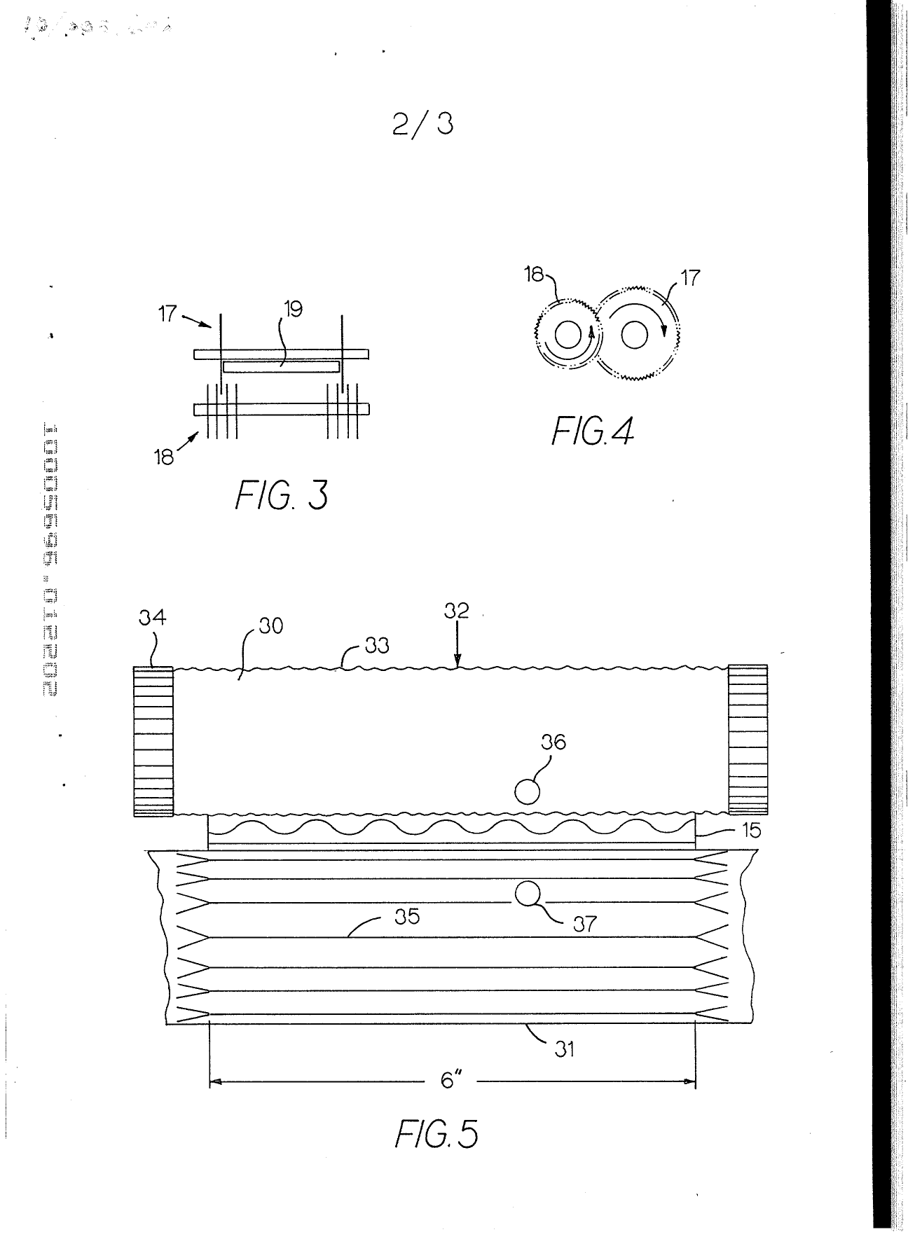

As suggested by the FIG. 5 embodiment, other tools may be used for shaping and processing the tire tread strips in transit through the edge trimmer embodiment heretofore discussed. The six inch wide strip 15 is thus drawn perpendicularly into the drawing sheet by the two rotating rollers 30, 31, which are biassed together as indicated by arrow 32 to squeeze the strip and pull it in its transport path at the transit speed. The outer surface of the roller 30, driven by appropriate gearing 34, is knurled to grasp the tread surface of the tread strip being processed and the outer surface of the roller 31 is rotated to engage the fabric side of the tread strip opposite to the tread face.

Spaced carbide blades 33 extending inwardly from the ends of roller 31 radially are of a dimension for indenting the outer edge regions of the tread strip being processed. It is at this region near the sidewalls that the most pronounced stresses are retained that prevent the tire tread strip from lying flat. Thus, it is more difficult to stack the processed tire tread strips closely together in multiple layer stacks without relieving the memorized tensions in the strips. The indenting blades 33 thus process the fabric side of the tire strip to re-leave the tendency to curl. The blades may be spaced at suitable spacings and have suitable lengths to process a selected set of similar tires, such as truck sizes, or those from a particular manufacturer.

If it is desired to reshape the tire treads with apertures extending through the strips, suitable roller die sets 36, 37 may be carried at desired locations for cutting the desired apertures though the tire tread strip. An alternative to this preferred embodiment of relieving stress is achieved by laser illumination.

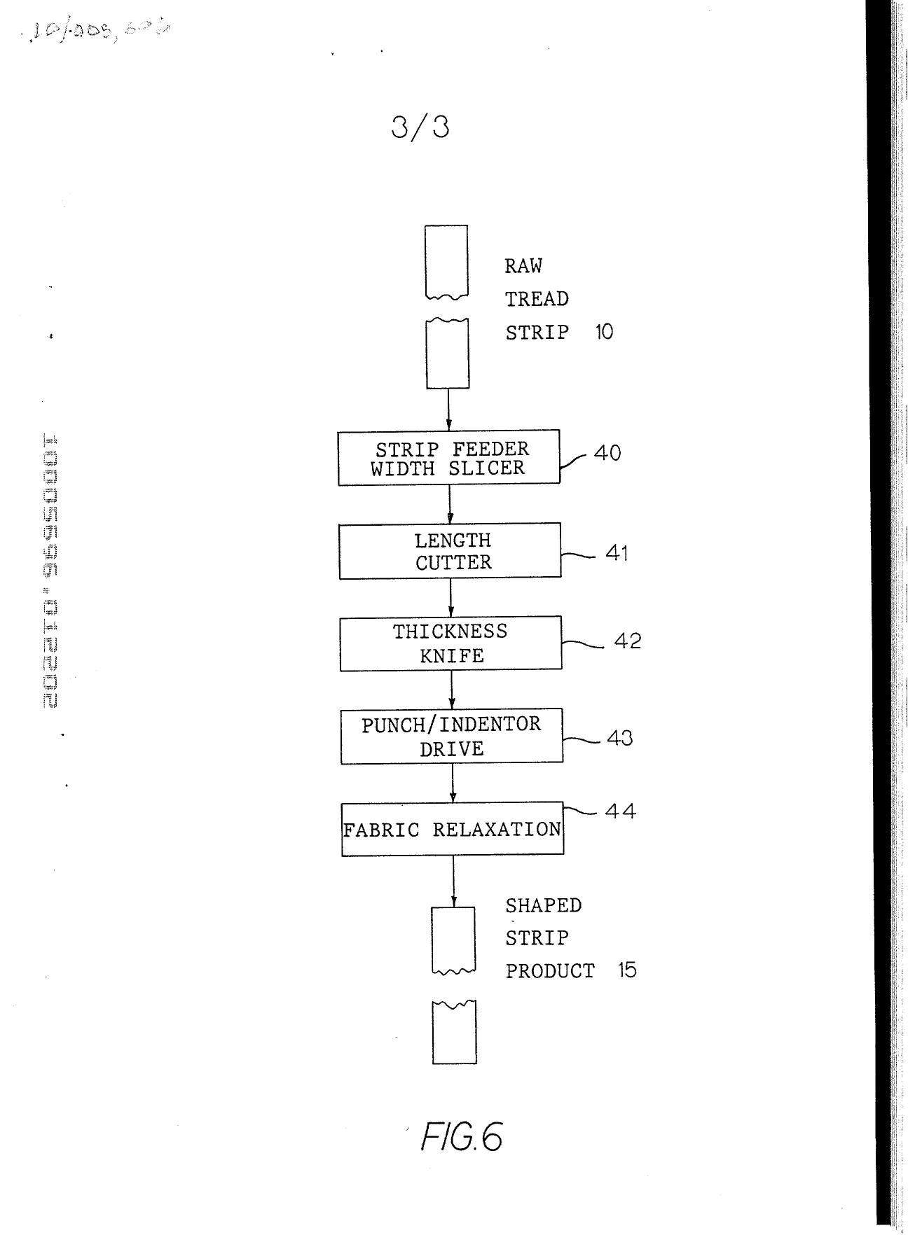

In the block diagram of FIG. 6, a tire tread strip processing system is shown for sequentially performing several shaping features during the transport of a strip through a transit path. Thus, thickness, length, width, and miscellaneous shaping of the strips are achieved in the simplified mechanism and method afforded by this invention.

The transit mechanism for the tire tread strip sequential transit path includes the strip feeder 40 (FIG. 2) into which the strips are manually fed, and the indentor drive mechanism (FIG. 5). Because of the constant speed transit, the strip may be cut at a desired length at station 41 by a simple timing device either electronically or mechanically triggered to cut off the trailing edge of the strips. If the fed end of the strip is not precisely shaped, the slicer may cut both leading and trailing edges.

At station or step 42, a precise thickness of the tread strip may be established by a slicing knife encountering the tread surface as it is pulled onward by the drive mechanism of the indentor 43.

Station or step 44 may either directly or additionally relax preformed tensions in the tire strip and is for example a laser illumination device.

It is seen therefore that this invention has advanced the status of the art and accordingly those novel features afforded by this invention are defined with particularity in the following claims.

1. The method of processing substantially rectangular shaped tread strips salvaged from tire carcasses having two shorter ends and two longer sides to obtain patterned strips of precise dimension and shape comprising in combination the steps of:
passing the strips from one end longitudinally through a power actuated strip feeder, and
shaping the strips along their length during the transit of the strips through the strip feeder.

2. The method of claim 1 comprising the more detailed shaping step of slicing off edge portions of the strips to obtain a strip of precision width during transport of the tread strips though the strip feeder.

3. The method defined in claim 1 comprising the more detailed shaping step of introducing a set of longitudinally spaced patterns along opposite strip longitudinal edges.

4. The method of claim 3 wherein said patterns comprise indentations in a surface of the tread strip opposite to the tread.

5. The method defined in claim 1 comprising the more detailed shaping step of punching apertures through the tread strip.

6. The method defined in claim 1 comprising the more detailed shaping step of cutting at least one end of the tread strip to define a tread strip of precision length.

7. The method defined in claim 1 comprising the more detailed shaping step of shaving the tread surface of the tread strip to establish tread strips of uniform thickness.

8. The method defined in claim 1 comprising the more detailed shaping step of shaping the tread strips in different ways at two sequential stations along the strip transit path.

9. The method defined in claim 8 further including the step of synchronizing the timing of the shaping step procedures at the two sequential stations to precisely locate the respective shaping procedures at the two stations at designated regions along the length of the tread strips.

10. Apparatus for processing substantially rectangular shaped tread strips salvaged from tire carcasses having two shorter ends and two longer sides to obtain patterned strips of precise dimension and shape comprising in combination: power actuated strip feeder means for grasping one shorter end of the tread strips and passing them through a linear transit path, and strip shaping means along the length thereof operable during the transit of the strips through said linear transit path.

11. The apparatus of claim 10 further comprising means for providing tread strips of uniform width from tread strips for producing precisely dimensioned products with stacked layers of tread strips having slicing means operable at designated spacings near opposite edges of raw input tread strips to cut away edges and produce uniform longitudinal strip widths between said two shorter ends as the strips pass through the strip feeder.

12. Apparatus defined in claim 10 wherein the strip shaping means comprises two sequential shaping devices for shaping the tread strips in different ways at two sequential stations along the strip transit path.

13. The apparatus defined in claim 12 further including timing means for synchronizing the timing of the shaping step procedures at the two sequential stations to precisely locate the respective shaping procedures at the two stations at designated regions along the length of the tread strips.

14. Apparatus as defined in claim 10 wherein the shaping means comprises indentation means for introducing a set of longitudinally spaced indentation patterns extending along the length of the strips and disposed along opposite strip longitudinal edges.

15. The apparatus of claim 14 wherein said indentation patterns comprise indentations in a surface of the tread strip opposite to the tread.

16. Apparatus in claim 10 wherein the shaping means comprises punching means for punching apertures through the tread strip.

17. Apparatus defined in claim 10 wherein the shaping means comprises cutting means for laterally cutting at least one end of the tread strip to define a tread strip of precision length.

18. Apparatus defined in claim 10 wherein the shaping means comprises means for removing tread surface from the tread strip to establish tread strips of uniform thickness.
